(19) United States
(12) Patent Application Publication
(10) Pub. No.: US 2015/0278920 A1
(43) Pub. Date: Oct. 1, 2015

(54) Network Nodes and Methods for Providing Recommendations on Gifts

(71) Applicant: TELEFONAKTIEBOLAGET L M ERICSSON (PUBL), Stockholm (SE)

(72) Inventor: Vincent Huang, Sollentuna (SE)

(21) Appl. No.: 14/431,810

(22) PCT Filed: Sep. 27, 2012
(86) PCT No.: PCT/SE2012/051029

§ 371 Date: Mar. 27, 2015

(51) Int. Cl. G06Q 30/06

(52) U.S. Cl. CPC G06Q 30/0633

(57) ABSTRACT

Network nodes (110, 120, 130) and methods for providing a first set of recommendations on a gift to a further user (151). A first network node (110) receives (201) a first query for recommendations, comprising identification of the further user (151). The first query transforms (203) into a second query, comprising the identification, while taking a user profile for a user (141) of the user device (140) into account. The first network node (110) sends (205) the second query to a second network node (120), which generates (206) a third set of recommendations based on the second query and information about recommendations. The second network node (120) sends (209) the third set to a third network node (130), which generates (210) a second set of recommendations based on a further user profile of the further user (151) and the third set. The third network node (130) sends (211) the second set to the second network node (120), which sends (212) the second set to the first network node (110). The first network node (110) determines (213) the first set based on the second set and the user profile. The first network node (110) sends (215) the first set to the user device (140).

### TECHNICAL FIELD

Embodiments herein relate to computer networks, such as gift recommendation systems. In particular, a first network node and a method therein for providing a first set of recommendations on a gift, a second network node and a method therein for providing a second set of recommendations on the gift, and a third network node and a method therein for assisting the second network node in providing the second set of recommendations are disclosed.

### BACKGROUND

With increased commercialization, the amount of goods consumed by people has increased steadily. Particularly, during the holiday seasons, gifts are bought to different recipients, such as family, friends and relatives. Many gifts are not really desired by the recipient. As a consequence, these gifts may be wasted, such as thrown away or put away. In order to avoid this kind of waste of gifts, so called gift recommendations systems has been developed. The gift recommendations systems provide, by means of input from a buyer, recommendations on what to buy. Thanks to the gift recommendation systems, it is intended that the gifts will in fact be desired by the recipient. Thus, the gifts may not necessarily be wasted.

A known gift recommendation system comprises a central computer and a database with information about available gifts, such as products and services. A buyer accesses the central computer via a web-browser. The central computer provides a web page which is displayed to the buyer. At the web page, the buyer inputs information about a recipient to whom a gift is to be bought. The information about the recipient relates to age and gender of the recipient and the occasion for the gift, e.g. birthday, new-born, grandparent etc. Based on the information about the recipient, the recommendation system makes a recommendation on the gift to buy. The better the buyer knows the recipient, the better will the recommendation be. Therefore, for example when the buyer does not know the recipient well enough, a problem with the abovementioned gift recommendation system may be that the gift is sometimes not desired by the recipient.

### SUMMARY

An object of embodiments herein is to improve the gift recommendation system mentioned above.

According to an aspect, the object is achieved by a method in a first network node for providing a first set of recommendations on a gift to a further user. The first network node receives, from a user device, a first query for recommendations on the gift. The first query comprises an identification of the further user. The first network node transforms the first query into a second query for recommendations on the gift while taking a user profile for a user of the user device into account. The second query comprises the identification of the further user. The first network node sends the second query to a second network node. The first network node receives a second set of recommendations on the gift from the second network node. The first network node determines the first set of recommendations on the gift based on the second set of recommendations and the user profile. Then, the first network node sends the first set of recommendations on the gift to the user device.

According to another aspect, the object is achieved by a first network node configured to provide a first set of recommendations on a gift to a further user. The first network node comprises a processing circuit configured to receive, from a user device, a first query for recommendations on the gift. The first query comprises an identification of the further user. Moreover, the processing circuit is configured to transform the first query into a second query for recommendations on the gift while taking a user profile for a user of the user device into account. The second query comprises the identification of the further user. Furthermore, the processing circuit is configured to send the second query to the second network node, to receive a second set of recommendations on the gift from a second network node, to determine the first set of recommendations on the gift based on the second set of recommendations and the user profile, and to send the first set of recommendations on the gift to the user device.

According to a further aspect, the object is achieved by a method in a second network node for providing, to a first network node, a second set of recommendations on a gift to a further user. The second network node receives a second query for recommendations on the gift from the first network node. The second query comprises an identification of the further user. The second network node generates a third set of recommendations on the gift based on the second query and information about recommendations on gifts. The second network node sends the third set of recommendations to a third network node for managing information about the further user. Then, the second network node receives the second set of recommendations from the third network node and sends the second set of recommendations to the first network node.

According to a still further aspect, the object is achieved by a second network node configured to provide, to a first network node, a second set of recommendations on a gift to a further user. The second network node comprises a processing circuit configured to receive a second query for recommendations on the gift from the first network node. The second query comprises an identification of the further user. The processing circuit is further configured to generate a third set of recommendations on the gift based on the second query and information about recommendations on gifts. Moreover, the processing circuit is configured to send, to a third network node for managing information about the further user, the third set of recommendations and the identification of the further user. Furthermore, the processing circuit is configured to receive the second set of recommendations from the third network node, and to send the second set of recommendations to the first network node.

According to yet another aspect, the object is achieved by a method in a third network node for assisting a second network node in providing a second set of recommendations on a gift to a further user. The third network node receives a third set of recommendations on the gift from the second network node and an identification of the further user. Furthermore, the third network node generates the second set of recommendations based on a further user profile of the further user and the third set of recommendations on the gift. Next, the third network node sends the second set of recommendations to the second network node.

According to still another aspect, the object is achieved by a third network node configured to assist a second network node in providing a second set of recommendations on a gift to a further user. The third network node comprises a processing circuit configured to receive a third set of recommendations on the gift from the second network node and an identification of the further user. Moreover, the processing circuit is further configured to generate the second set of recommendations based on a further user profile of the further user and the third set of recommendations on the gift. Furthermore, the processing circuit is configured to send the second set of recommendations to the second network node.

Thanks to that the identification of the further user is provided to the third network node via the second network node, the third network node is able to generate the second set of recommendations based on the further user profile of the further user and the third set of recommendations on the gift. Thus, the second set of recommendations may be adapted to the further user profile, which for example may comprise information about interests of the further user. Therefore, since the further user profile may reflect what the further user desires, the second set of recommendations is more personalized, or customized, to the further user. Hence, a chance for that the further user in fact does desire, and like, the gift(s) suggested according to the second set of recommendations is/are increased. Now, the first network node determines the first set of recommendations based on the second set of recommendations. Accordingly, also the first set of recommendations is improved with respect to the further user profile. Thus, an improvement of the first set of recommendations is achieved.

An advantage of embodiments herein is that fewer gifts, which are not desired by the further user, e.g. a recipient, are recommended by the first network node. Expressed differently, the chance that the gifts recommended are actually desired by the recipient is increased.

A further advantage of some embodiments herein is that information about recommendations on gifts is handled separately from the user profile and the further user profile. Thus, these embodiments avoid mixing of information about recommendations on gifts, the user profile and the further user profile. The mixing of information may violate privacy of the user and/or the further user. Violation of privacy is consequently avoided.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a block diagram, which shows an exemplifying computer network,

FIG. 2 is a schematic, combined signaling scheme and flowchart of embodiments of a method in the computer network according to FIG. 1,

FIG. 3 is a schematic flow chart illustrating embodiments of the method in the first network node,

FIG. 4 is a schematic block diagram illustrating embodiments of the first network node,

FIG. 5 is a schematic flow chart illustrating embodiments of the method in the second network node,

FIG. 6 is a schematic block diagram illustrating embodiments of the second network node,

FIG. 7 is a schematic flow chart illustrating embodiments of the method in the third network node, and

FIG. 8 is a schematic block diagram illustrating embodiments of the third network node.

### DETAILED DESCRIPTION

Throughout the following description similar reference numerals have been used to denote similar elements, network nodes, parts, items or features, when applicable.

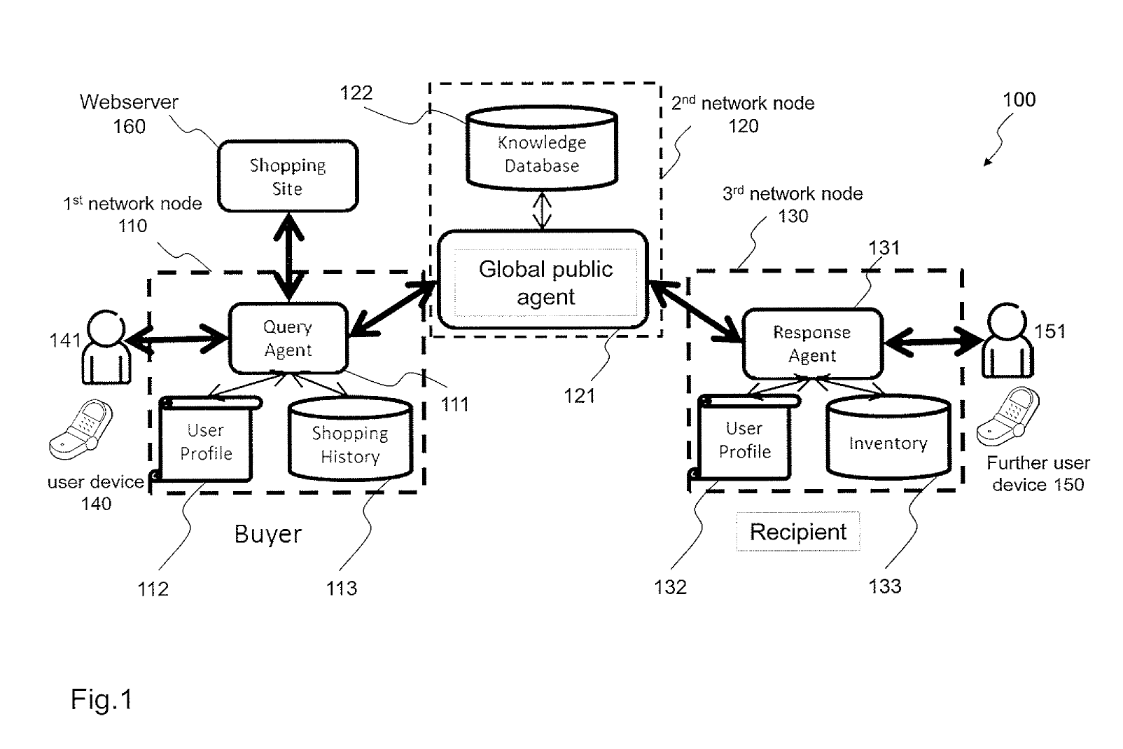

FIG. 1 depicts an exemplifying computer network 100 in which embodiments herein may be implemented. In this example, the computer network 100 is a gift recommendation network, or a gift recommendation system.

The computer network 100 comprises a first network node 110, a second network node 120 and a third network node 130. In this manner, the first, second and third network nodes constitute a co-operative gift recommendation network. The first, second and third network nodes 110, 120, 130 may be deployed in the so called cloud. Hence, the computer network 100 may be at least a portion of the cloud. The term “cloud” is known from for example the field of cloud computing and the like.

As used herein, the term “network node” refers to one or more computers and/or one or more software components by means of which the first, second and third network node as described herein may be implemented. The term “software component” may refer to an application program, an application, a program, a software module, a software library or the like.

The first network node 110 may comprise a query agent 111, which also may be a network node in the sense as defined above. The first network node 110, i.e. the query agent 111, may be invoked by a user 141 by use of a user device 140. This means that the user 141 interacts with the query agent 111 via the user device 140, not by directly manipulating the query agent 111. Furthermore, the first network node 110 may comprise a user profile 112, which may be a database comprising information about the user 141. The information about the user 141 may relate to gender, age, home address, county of residence, interests, preferred price range for gifts, favorite color, etc. In addition, the first network node 110 may comprise information about purchases by the user 141, e.g. a shopping history 113. As an example, the information about purchases may comprise one or more of article numbers, name and price of previously purchased gifts. In some examples, the shopping history 113 is implemented as a separate network node.

The second network node 120 may comprise a global public agent 121, which also may be a network node in the sense as defined above. Furthermore, the second network node 120 may comprise information about recommendations on gifts, such as a knowledge database 122. Again, the knowledge database 122 may be a network node in the sense as defined above. As an example, the knowledge database may comprise information relating to which gifts are likely to be desired given certain information about a recipient, such as a further user 151. As will be described in the following paragraph, the certain information may be provided by means of a further user profile 132. For example, the knowledge database may indicate that a middle-aged man may prefer to receive a tie as a gift, while a middle-aged woman may prefer to receive perfume as a gift. In addition, the knowledge database may provide information about gifts depending on occasion, such as birthday, session holiday, anniversary or the like.

The third network node 130 may comprise a response agent 131, which also may be a network node in the sense as defined above. The third network node 130 may be accessed by a further user 151 by use of a further user device 150.

Furthermore, the third network node 130 may comprise a further user profile 132, which may be a database comprising information about the further user 151. The information about the further user 151 may relate to gender, age, home address, county of residence, interests, preferred price range for gift, favorite color, etc. In addition, the third network node 130 may comprise an inventory 133. As an example, the inventory 133 may comprise one or more of article numbers, name and price of gifts, which the recipient desires. It may even be that some gifts according to the inventory are in fact marked as not desired. Then, the inventory may be used to remove unwanted gifts. In some examples, the inventory 133 is implemented as a separate network node.

In some embodiments, the first and third network node 110, 130 is the same network node. Expressed differently, the first network node 110 may comprise the third network node 130, or vice versa.

Furthermore, a webserver 160 may host a shopping site from which gifts may be bought. The webserver 160 may be included in the computer network 100 or may be separated from the computer network 100.

As used herein, the term “gift” may refer to a product and/or service. Thus, the gift may be a vase, a pencil, a hat, a robe, a toy, a piece of kitchenware, a meal at a restaurant, a parachute jump, a spa-weekend or the like.

Throughout the present disclose, any network node may comprise a database for storing of information, such as the shopping history 113, the inventory 133, the knowledge database 122 or the like. Any network node may here refer to the first, second, third network nodes, the webserver, the shopping history, the inventory, the user profile, the further user profile or other entity described herein.

As used herein, the term “user device” may refer to a wireless device, a radio communication device, a user equipment, a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic switch, a microphone, a loudspeaker, a camera sensor etc.

In the following, a brief description of how the computer network 100 may be used is presented. A user called Bob, as an example of the user 141, is living in London. He is invited to Alice's 30's birthday party in New York. Alice is taken as an example of the further user 151. Bob cannot decide what gift he will bring to Alice. He queries the Gift Shopping Recommender System (GSRS), which is an example of the computer network 100, and allows the system to send an anonymous query to Alice. In more detail, the anonymous query may be sent by the response agent 131 to the further user device 150. After a while, Alice receives a birthday gift wish list form, from the GSRS, indicating it is from one of her friends. All of them are very interesting for her, but she removes some recommendations on gifts which she knows her parents will buy for her. Bob receives a list, as an example of the first set of recommendations, from the GSRS system and he chooses a watch with London 2012 Olympic motif. In more detail, the list may be received, by the user device 140, from the query agent 111.

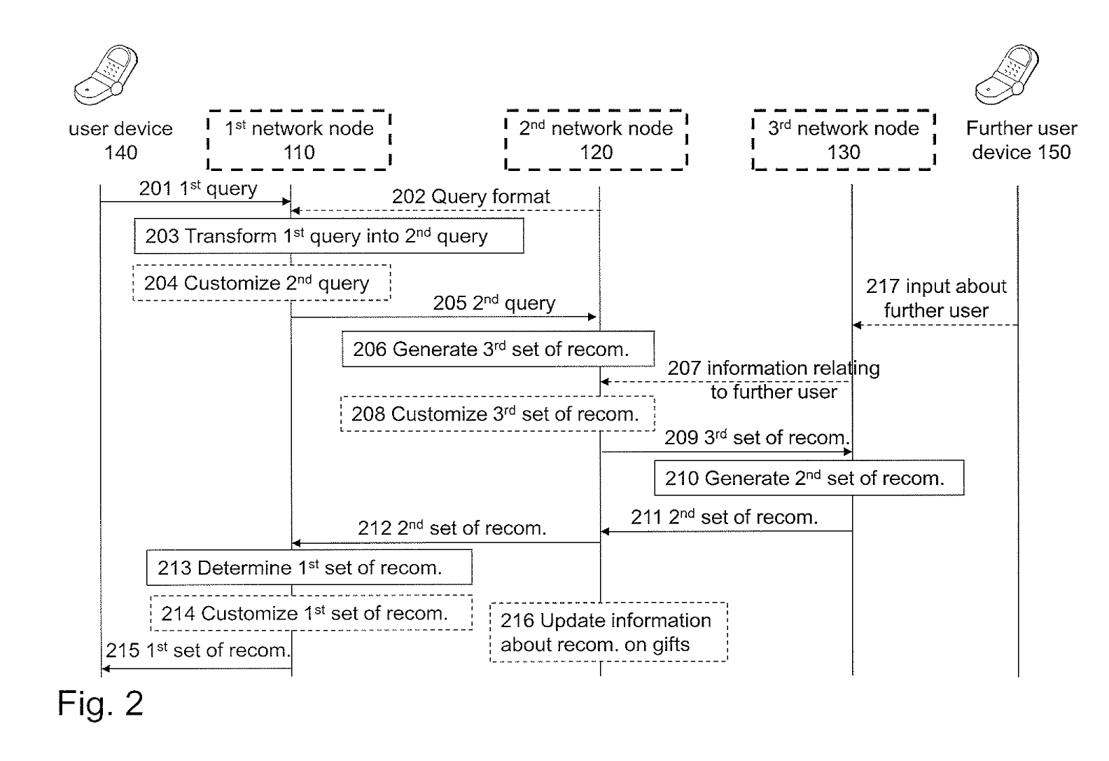

FIG. 2 illustrates an exemplifying method for providing a first set of recommendations on a gift when implemented in the computer network 100. The user 141 may wish to give a gift to the further user 151. In order to obtain assistance in finding out what to give, the user 141 consults the computer network 100, which is configured to provide recommendations on gifts. Hence, the first set of recommendations may be provided to the user 141 via the user device 140, for example by displaying the first set of recommendations on a display of the user device 140. The user device 140 has obtained the first set of recommendations from the first network node 110.

The following actions may be performed in any suitable order.

### Action 201

In order for the user 141 to obtain a recommendation, or multiple recommendations, on what to give, the user 141 inputs a first query on for example a webpage of the shopping site, hosted by the webserver 160. Then, the first network node 110 receives, from the user device 140, the first query for recommendations on the gift. The first query comprises an identification of the further user 151, such as an identifier that is only known to the first and third network nodes 110, 130. The identification of the further user 151 will be used in action 210. Moreover, the identification of the further user 151 may be used for identifying the third network node 130 as shown in action 209. Furthermore, the identification of the further user 151 may be known to the user device 140 thanks to that for example the webpage displays a list of recipients. Each recipient is associated to a respective identification. In some examples, the recipient may be identified by an email address, a user name, a facebook ID or the like.

The first network node 110 may handle authorization of access for example by checking a user name and a password, provided by the user 141 and comprised in the first query.

When the first network node 110, e.g. the query agent 111, has received the first query from the user 141, the first network node 110 may complete, or transform, the first query according to action 203 and/or 204.

### Action 202

An indication about the query format may be used to make the first network node 110 aware of how a second query, to be sent in action 205, shall be formatted and which information is to be provided therein. Thus, the first network node 110 may receive the indication about the query format from the second network node 120. In other examples, the query format may be fixed or predetermined.

As an example, the query format may specify that the second query comprises:

one of the following ranges relating to age: 0-3, 4-10, 11-19, 20-29, 30-49, 50-110;

gender: man or woman; and

personality type: philosopher or sporty.

Moreover, the query format may specify any kind of aggregated personal information, such as income range, living area, hobby, marital status, number of children.

Similarly, in some embodiments, the query format may comprise information about how the first query is formatted and/or which information is provided in the first query.

### Action 203

The first network node 110 transforms, for example according to the query format, the first query into a second query for recommendations on the gift while taking a user profile for a user 141 of the user device 140 into account. The second query comprises the identification of the further user 151.

In this manner, the first network node 110 may filter out private information about the user 141 from the first query. Merely, the identification of the further user 151 and information about the user 141 is forwarded, by the first network node 110, to the second network node 120. The information about the user 141 may be formatted according to the query format. Filtering out private information may be to specify a range of age, such as 30-49 years when the first query indicates that the user 141 is 45 years old. In this manner, private information about exact age, such as 45, is hidden within the range of 30-49 years.

As mentioned, the identification of the further user 151 may be an identifier of the further user 151 that is only known to the first and third network nodes 110, 130. Thereby, the second network node 120 does not obtain any private or sensitive information that may be connected, by the second network node 120, to the further user 151. As an example, when the further user 151, and/or also the user 141, registers to be able to use the gift recommendation system the identification of the further user 151 may be created. A user agent, which may comprised in the gift recommendation system or separate therefrom, may be associated with the identification when the further user 151 registers with the gift recommendation system.

Thanks to that the first query is transformed into a second query, privacy may be protected. Advantageously, private information, such as the user profile 112, is kept within the first network node 110.

### Action 204

The first network node 110 may customize the second query based on information about purchases by the user 141. The information about purchases may be stored in the shopping history 113 for the user 141. Thanks to the customization of the second query, recommendations provided by the computer network 100 may become more personalized as will be explained by the following example.

The information about purchases may indicate that the user 141 usually buys gifts at a certain price level for some specific kind of gifts, such as wedding gifts, birthday gifts or the like. Then, information about the certain price level may be added to the second query. Thereby, providing a more extensive basis on which the second node 120 may generate the third set of recommendations. As a result, the recommendations on gifts, as given by the third set of recommendations, may become more personalized to the user 141.

In some examples, the first network node 110 removes some information from the second query in order to protect privacy of the user 141 and/or the further user 151. This is beneficial when a number of users, such as the user 141 and/or the further user 151, which may be matched to the second query, is below a predetermined threshold value. This means for example that when only a few number of users fits to the description provided by the second query, i.e. the second query is very detailed, then the first network node 110 removes some information in order to avoid that privacy of these few users may be violated. As an example, the information in the second query may only be matched to 3 persons. Then, some information in the second query is removed such that the second query now can be matched to 40 persons. Thus, ensuring privacy of the 3 persons, which are hidden within the 40 persons.

In actions 203 and 204, the first network node 110 may thus complete the first query with the information from the user profile 112 and/or the information about purchases, e.g. the shopping history 113. Examples of information provided by the user profile 112 and/or the information about purchases are, some of which has already been mentioned:

Buyer info: age, gender, location, price range, etc.

Receiver info: agent ID, such as Uniform Resource Locator (URL), age, gender, location, etc.

Occasion: time, special keywords like birthday, wedding etc.

### Action 205

Now that the second query does not comprise any private information about the user 141 and/or the further user 151, the first network node 110 sends 205 the second query to the second network node 120. The second query comprises the identification of the further user 151. As previously mentioned, private information may relate to information about preferences that may be linked to a person without any special knowledge about for example the identification of the further user 151. In this manner, it may be made possible for the second network node 120 to use the second query and information about recommendations on gifts in action 206 and/or 208.

Expressed differently, in order to make use of the information about recommendations on gifts, e.g. the knowledge database 122, which is accessible through the second network node 120, the second query is provided to the second network node 120. Thus, the second network node 120 receives 205, from the first network node 110, the second query for recommendations on the gift.

### Action 206

The second network node 120 generates a third set of recommendations on the gift based on the second query and information about recommendations on gifts, such as the knowledge database 122. In this manner, the second network node 120 has generated the third set of recommendations as a generic list of recommendations which takes into account the information provided in the second query.

### Action 207

The second network node 120 may receive information relating to the further user 151 from the third network node 130. In action 208, the information relating to the further user 151 may be used to customize, or refine, the third set of recommendations on the gift. The information relating to the further user 151 may be extracted from the further user profile 132. As an example, if the further user profile 132 indicates an age of 35, the information provided to the second network node 120 may be that the further user 151 has an age in the range of 30 to 49. This is particular useful if the information provided in the second query was incomplete, or did not due to for example the query format, provide such age range.

### Action 208

This action may be performed when action 207 has been performed. Thus, when information relating to the further user 151 has been provided to the second network node 120, the second network node 120 may customize the third set of recommendations based on the information relating to the further user 151. As an example, the second network node 120 may re-generate the third set of recommendations on the gift, but also taking the received, in action 207, information about the further user 151 into account.

### Action 209

The second network node 120 sends, to the third network node 130, the third set of recommendations and an identification of the further user 151. Thanks to that the third set of recommendations on the gift is sent to the third network node 130, the third network node 130 is be able to process the third set of recommendations on the gift in action 210.

### Action 210

The third network node 130 generates the second set of recommendations based on the further user profile of the further user 151 and the third set of recommendations on the gift. Thus, the second set of recommendations is made more personalized, or customized, to the further user 151 as given by the further user profile.

The third network node 130 may further generate the second set of recommendations based on inventory of the further user 151. The inventory of the further user 151 may comprise information about gifts that the further user 151 already has received. Thus, any recommendations towards a gift that the further user 151 already has received may be removed from the second set of recommendations.

Expressed somewhat differently, the response agent 131 may receive the third set of recommendations from the global public agent 121. The response agent 131 may filter the third set of recommendations with the further user profile 132, such as interests and hobby and the inventory 133. The response agent 131 may check the gifts of the third set of recommendations and may also refine the third set of recommendations by filling more information about the further user 151 and send it back to the global public agent 121 as the second set of recommendations. In other examples, the further user 151 may manually change, or customize, the third set of recommendations by for example adding or removing gifts to/from the third set.

### Action 211

Now that the second set of recommendations is made customized to the further user 151, it may be returned, i.e. sent, to the second network node 120. Therefore, the second set of recommendations is transferred from the third network node 130 to the second network node 120.

### Action 212

In order to provide the first network node 110 with the second set of recommendations, the second network node 120 sends the second set of recommendations to the first network node 110. Next, the first network node 110 may use, in action 213, the second set of recommendations.

In some examples, the first network node 110, such as the query agent 111, performs the shopping, i.e. the actual purchase. Then, when the query agent 111 may have received a response in the form of the second set of recommendations, as in the present action, from the global public agent 121, the user 141 may choose one gift out of the first set of recommendations. Then, the first network node 110 may automatically connect to the shopping site on the webserver 160 to perform the shopping. Moreover, the first network node 110 may log the user's 141 choice, for instance by registering the choice in the shopping history 113.

### Action 213

The first network node 110 determines the first set of recommendations on the gift based on the second set of recommendations and the user profile.

As an example, the first set of recommendations on the gift may be a subset of the second set of recommendations. It may be that the second query does not comprise some information, such as preferred store or the like, provided in the user profile. Then, any recommendations of the second set of recommendations not fulfilling e.g. a criterion of preferred store, will not be included in the first set of recommendations. Here, preferred store relates to for example a department store.

### Action 214

Thanks to that the first network node 110 may access the information about purchases, such as a database 113 of shopping history for the user 141, the first network node 110 may customize the first set of recommendations on the gift based on information about purchases by the user 141. For example, any gifts recently bought by the user 141 may be removed from the first set of recommendations.

### Action 215

In order for the user 141 to obtain, for example read, information about the first set of recommendations, the first network node 110 sends the first set of recommendations on the gift to the user device 140. The user device 140 may then display a text corresponding to the first set of recommendations.

Now, the user 141 may choose to buy one or more gifts from the first set of recommendations. The user's choices may only be stored as information about purchases, e.g. in the shopping history 113.

### Action 216

In some embodiments, the second network node 120 may update the information about recommendations on gifts while taking the second set of recommendations on the gift into account. In this manner, the information about recommendations on gifts, such as the knowledge database 122, may learn from the difference between the third set of recommendations and the second set of recommendations. Therefore, the second network node 120 may include functionality for adaptive learning based on the third set of recommendations and the second set of recommendations.

As an example, the global public agent may build the knowledge database on all gifts and features assigned to each gift using machine learning (ML). The features are information from the second query and are used as input to the machine learning. The machine learning assigns weight to the relations between features and gifts. The weights can be found by using e.g. neural network.

However, to protect privacy of the user and/or the further user, there may be set a limit for how much information the query format may specify. This means that if the computer network 100 may specify a maximum number for how many of these parameters should be used. As an example, a function in the second network node estimates the total number of persons which can satisfies the descriptions. When the total number is below a certain threshold, no more information can be inputted.

### Action 217

In some examples, the third network node 130 may send a question, e.g. a message including information about the question, to the further user 151 in order to improve the generation in action 210. Thus, the third network node 130 may receive input about the further user 151 from the further user device 150, preferably in response to the question.

The information relating to the further user 151, as in action 207, may comprise the input about the further user 151. It may be preferred that the input about the further user 151 is converted according to the query format. In this manner, the second network node 120 is given additional information which was used in action 208.

According to the embodiments described in conjunction with FIG. 2, the computer system 100 provides the user device 140 with the first set of recommendations on the gift. Thanks to that the identification of the further user 151 is passed to the third network node 130, via the second network node 120, the second set of recommendations may be customized, based on the further user profile 132, to the recipient, i.e. the user 151, of the gift. In some examples, the second set of recommendations is further based on the inventory 133. In turn, the first set of recommendations may also be customized to the user 151, since the first set of recommendations is determined by the first network node 110 based on the second set of recommendations. Thus, an improved computer system for providing recommendations on the gift is obtained.

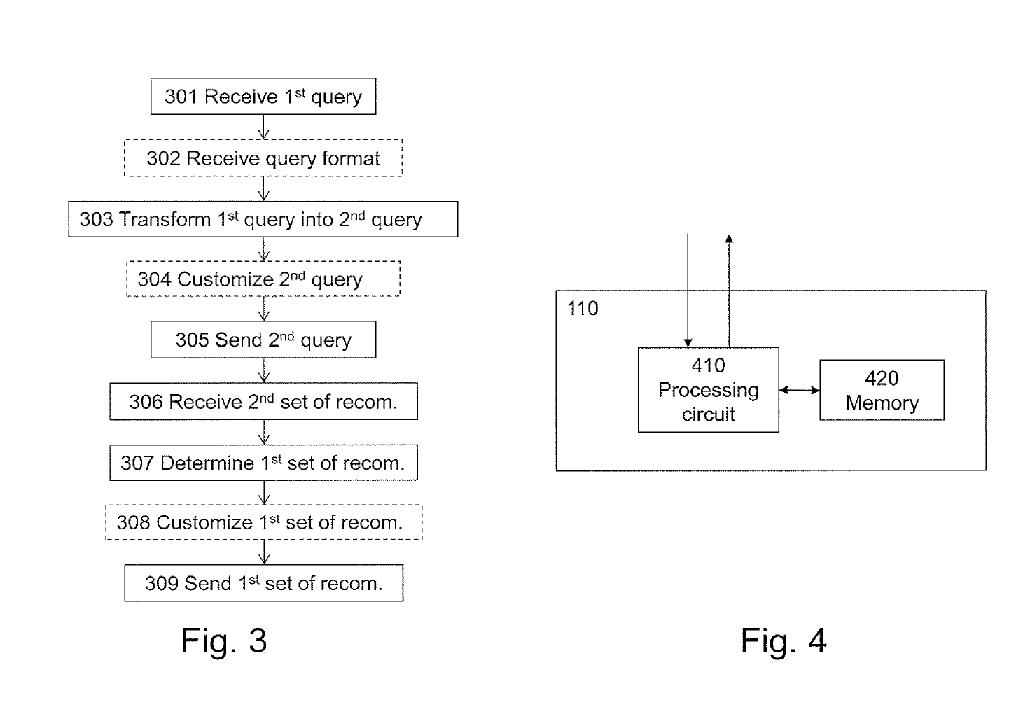

FIG. 3 shows embodiments of the exemplifying method in the computer network node 100, when seen from the first network node 110. Thus, the first network node 110 performs a method for providing the first set of recommendations on the gift to the further user 151.

The following actions may be performed in any suitable order.

### Action 301

The first network node 110 receives 201, from the user device 140, the first query for recommendations on the gift. The first query comprises an identification of the further user 151. This action is similar to action 201.

### Action 302

The first network node 110 may receive an indication about the query format from the second network node 120. This action is similar to action 202.

### Action 303

The first network node 110 transforms 203 the first query into a second query for recommendations on the gift while taking a user profile for a user 141 of the user device 140 into account. The second query comprises the identification of the further user 151.

In some embodiments, the transforming 203 of the first query into the second query may comprise filtering out private information about the user 141 from the first query while transferring the identification of the further user 151 and information about the user 141, for example according to the query format, to the second network node 120.

This action is similar to action 203.

### Action 304

The first network node 110 may customize the second query based on information about purchases by the user 141. This action is similar to action 204.

### Action 305

The first network node 110 sends the second query to a second network node 120. This action is similar to action 205.

### Action 306

The first network node 110 receives a second set of recommendations on the gift from the second network node 120. This action is similar to action 212.

### Action 307

The first network node 110 determines the first set of recommendations on the gift based on the second set of recommendations and the user profile. This action is similar to action 213.

### Action 308

The first network node 110 may customize the first set of recommendations on the gift based on information about purchases by the user 141. This action is similar to action 214.

### Action 309

The first network node 110 sends the first set of recommendations on the gift to the user device 140. This action is similar to action 215.

With reference to FIG. 4, a schematic block diagram of the first network node 110 is shown. The first network node 110 is configured to perform the methods in FIGS. 2 and/or 3. Thus, the first network node 110 is configured to provide the first set of recommendations on a gift to the further user 151.

The first network node 110 comprises a processing circuit 410 configured to receive, from a user device 140, a first query for recommendations on the gift. The first query comprises an identification of the further user 151.

Moreover, the processing circuit 410 is configured to transform the first query into a second query for recommendations on the gift while taking a user profile for a user of the user device 140 into account. The second query comprises the identification of the further user 151.

Furthermore, the processing circuit 410 is configured to send the second query to the second network node 120, and to receive a second set of recommendations on the gift from a second network node 120.

The processing circuit 410 is further configured to determine the first set of recommendations on the gift based on the second set of recommendations and the user profile, and to send the first set of recommendations on the gift to the user device 140.

The processing circuit 410 may further be configured to customize the second query based on information about purchases by the user 141.

The processing circuit 410 may further be configured to customize the first set of recommendations on the gift based on information about purchases by the user.

The processing circuit 410 may further be configured to receive an indication about the query format from the second network node 120. Then, the processing circuit 410 may be configured to perform the transformation according to the query format.

The processing circuit 410 may further be configured to filter out private information about the user 141 from the first query and to transfer the identification of the further user 151 and information about the user 141 according to the query format to the second network node 120.

The processing circuit 410 may be a processing unit, a processor, an Application Specific Integrated Circuit (ASIC), a field-programmable gate array (FPGA), a signal processor, a Digital Signal Processer (DSP) or the like. As an example, the processing unit or the like may comprise one or more processor kernels.

The first network node 110 further comprises a memory 420 for storing software to be executed by, for example, the processing circuit. The software may comprise instructions to enable the processing circuit to perform the method in the first network node 110 as described above in conjunction with FIGS. 2 and/or 3. The memory may be a hard disk, a magnetic storage medium, a portable computer diskette or disc, flash memory, random access memory (RAM) or the like. Furthermore, the memory may be an internal register memory of a processor.

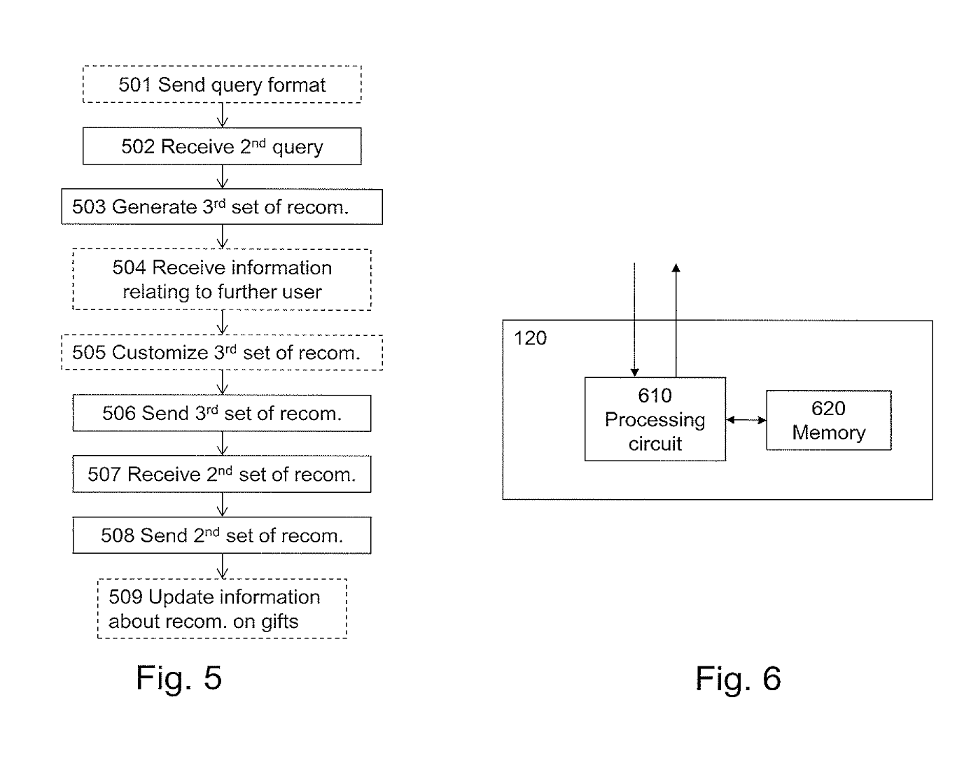

FIG. 5 shows embodiments of the exemplifying method in the computer network node 100, when seen from the second network node 120. Thus, the second network node 120 performs a method for providing, to the first network node 110, the second set of recommendations on the gift to the further user 151.

The following actions may be performed in any suitable order.

### Action 501

The second network node 120 may send an indication about the query format to the first network node 110. This action is similar to action 202.

### Action 502

The second network node 120 receives, from the first network node 110, a second query for recommendations on the gift. The second query comprises an identification of the further user 151. This action is similar to action 205.

### Action 503

The second network node 120 generates a third set of recommendations on the gift based on the second query and information about recommendations on gifts. This action is similar to action 206.

### Action 504

The second network node 120 may receive information about a further user profile for a recipient of the gift from the third network node 130. This action is similar to action 207.

### Action 505

The second network node 120 may customize the third set of recommendations based on the information about the further user profile. This action is similar to action 208.

### Action 506

The second network node 120 sends, to a third network node 130 for managing information about the further user 151, the third set of recommendations and the identification of the further user 151. This action is similar to action 209.

### Action 507

The second network node 120 receives the second set of recommendations from the third network node 130. This action is similar to action 211.

### Action 508

The second network node 120 sends the second set of recommendations to the first network node 110. This action is similar to action 212.

### Action 509

The second network node 120 may update the information about recommendations on gifts while taking the second set of recommendations on the gift into account. This action is similar to action 216.

With reference to FIG. 6, a schematic block diagram of the second network node 120 is shown. The second network node 120 is configured to perform the methods in FIGS. 2 and/or 5. Thus, the second network node 120 is to provide, to a first network node 110, a second set of recommendations on a gift to a further user 151.

The second network node 120 comprises a processing circuit 610 configured to receive, from the first network node 110, a second query for recommendations on the gift. The second query comprises an identification of the further user 151.

The processing circuit 610 is further configured to generate a third set of recommendations on the gift based on the second query and information about recommendations on gifts, and to send, to a third network node 130 for managing information about the further user 151, the third set of recommendations and the identification of the further user 151.

Furthermore, the processing circuit 610 is configured to receive the second set of recommendations from the third network node 130, and to send the second set of recommendations to the first network node 110.

The processing circuit 610 may further be configured to receive information relating to the further user from the third network node 130, and to customize the third set of recommendations based on the information relating to the further user.

The processing circuit 610 may further be configured to update the information about recommendations on gifts while taking the second set of recommendations on the gift into account.

The processing circuit 610 may be a processing unit, a processor, an Application Specific Integrated Circuit (ASIC), a field-programmable gate array (FPGA), a signal processor, a Digital Signal Processer (DSP) or the like. As an example, the processing unit or the like may comprise one or more processor kernels.

The second network node 120 further comprises a memory 620 for storing software to be executed by, for example, the processing circuit. The software may comprise instructions to enable the processing circuit to perform the method in the second network node 120 as described above in conjunction with FIGS. 2 and/or 5. The memory may be a hard disk, a magnetic storage medium, a portable computer diskette or disc, flash memory, random access memory (RAM) or the like. Furthermore, the memory may be an internal register memory of a processor.

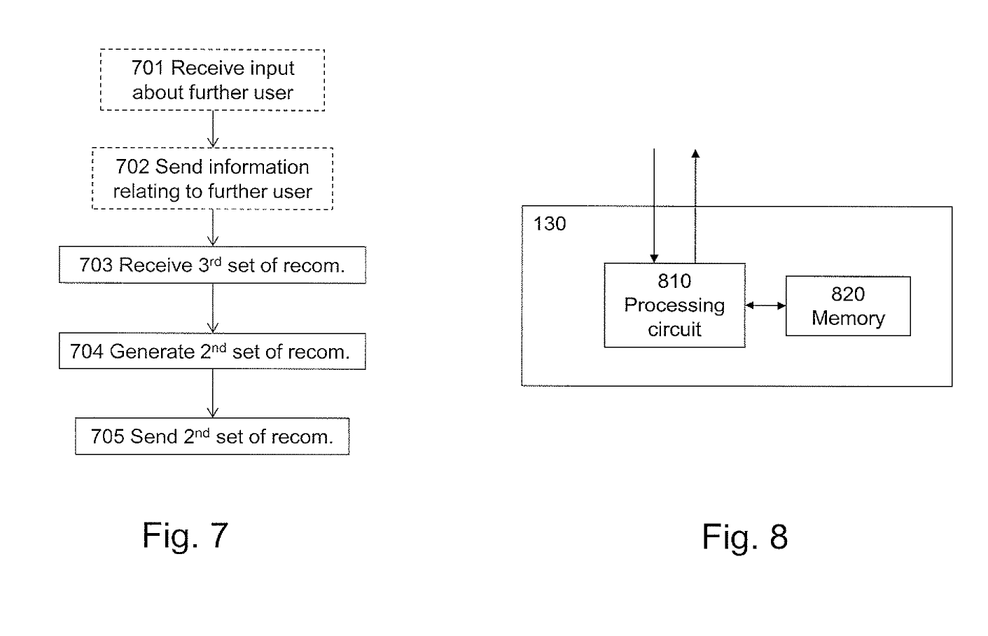

FIG. 7 shows embodiments of the exemplifying method in the computer network node 100, when seen from the third network node 130. Thus, the third network node 130 performs a method for assisting a second network node 120 in providing a second set of recommendations on a gift to a further user 151.

The following actions may be performed in any suitable order.

### Action 701

The third network node 130 may receive input about the further user 151 from the further user device 150. This action is similar to action 217.

### Action 702

The third network node 130 may send information relating to the further user 151 to the second network node 120. This action is similar to action 207.

### Action 703

The third network node 130 receives a third set of recommendations on the gift from the second network node 120 and an identification of the further user 151. This action is similar to action 209.

### Action 704

The third network node 130 generates the second set of recommendations based on a further user profile of the further user 151 and the third set of recommendations on the gift.

In some embodiments, the generation of the second set of recommendations may further comprise generating the second set of recommendations based on inventory of the further user 151.

This action is similar to action 210.

### Action 705

The third network node 130 sends the second set of recommendations to the second network node 120. This action is similar to action 211.

With reference to FIG. 8, a schematic block diagram of the third network node 130 is shown. The third network node 130 is configured to perform the methods in FIGS. 2 and/or 7. Thus, the third network node 130 is configured to assist the second network node 120 in providing the second set of recommendations on the gift to the further user 151.

The third network node 130 comprises a processing circuit 810 configured to receive a third set of recommendations on the gift from the second network node 120 and an identification of the further user 151.

Moreover, the processing circuit 810 is further configured to generate the second set of recommendations based on a further user profile of the further user 151 and the third set of recommendations on the gift.

Furthermore, the processing circuit 810 is configured to send the second set of recommendations to the second network node 120.

The processing circuit 810 may further be configured to generate the second set of recommendations based on inventory of the further user 151.

The processing circuit 810 may further be configured to send information about the further user to the second network node 120.

The processing circuit 810 may be a processing unit, a processor, an Application Specific Integrated Circuit (ASIC), a field-programmable gate array (FPGA), a signal processor, a Digital Signal Processer (DSP) or the like. As an example, the processing unit or the like may comprise one or more processor kernels.

The third network node 130 further comprises a memory 820 for storing software to be executed by, for example, the processing circuit. The software may comprise instructions to enable the processing circuit to perform the method in the third network node 130 as described above in conjunction with FIGS. 2 and/or 7. The memory may be a hard disk, a magnetic storage medium, a portable computer diskette or disc, flash memory, random access memory (RAM) or the like. Furthermore, the memory may be an internal register memory of a processor.

As used herein, the term “value” may be any kind of digit, such as binary, real, imaginary or rational number or the like. Moreover, “value” may be one or more characters, such as a letter or a string of letters. “Value” may also be represented by a bit string.

Even though embodiments of the various aspects have been described, many different alterations, modifications and the like thereof will become apparent for those skilled in the art. The described embodiments are therefore not intended to limit the scope of the present disclosure.

1-22. (canceled)

23. A method in a first network node for providing a first set of recommendations on a gift to a further user, comprising:
receiving, from a user device, a first query for recommendations on the gift, wherein the first query comprises an identification of the further user;
transforming the first query into a second query for recommendations on the gift while taking a user profile for a user of the user device into account, wherein the second query comprises the identification of the further user;
sending the second query to a second network node;
receiving a second set of recommendations on the gift from the second network node;
determining the first set of recommendations on the gift based on the second set of recommendations and the user profile; and
sending the first set of recommendations on the gift to the user device.

24. The method according to claim 23, further comprising customizing the second query based on information about purchases by the user.

25. The method according to claim 23, further comprising customizing the first set of recommendations on the gift based on information about purchases by the user.

26. The method according to claim 23, further comprising receiving an indication about a query format from the second network node, wherein the transforming is performed according to the query format.

27. The method according to claim 23, wherein the transforming of the first query into the second query comprises filtering out private information about the user from the first query while transferring the identification of the further user and information about the user to the second network node.

28. A method in a second network node for providing, to a first network node, a second set of recommendations on a gift to a further user, comprising:
receiving, from the first network node, a second query for recommendations on the gift, wherein the second query comprises an identification of the further user;
generating a third set of recommendations on the gift based on the second query and information about recommendations on gifts;
sending, to a third network node for managing information about the further user, the third set of recommendations and the identification of the further user;
receiving the second set of recommendations from the third network node; and
sending the second set of recommendations to the first network node.

29. The method according to claim 28, further comprising:
receiving information relating to the further user from the third network node; and
customizing the third set of recommendations based on the information relating to the further user.

30. The method according to claim 28, further comprising updating the information about recommendations on gifts while taking the second set of recommendations on the gift into account.

31. A method in a third network node for assisting a second network node in providing a second set of recommendations on a gift to a further user, comprising:
receiving a third set of recommendations on the gift from the second network node and an identification of the further user;
generating the second set of recommendations based on a further user profile of the further user and the third set of recommendations on the gift; and
sending the second set of recommendations to the second network node.

32. The method according to claim 31, wherein the generation of the second set of recommendations further comprises generating the second set of recommendations based on inventory of the further user.

33. The method according to claim 31, further comprising sending information relating to the further user to the second network node.

34. A first network node configured to provide a first set of recommendations on a gift to a further user, wherein the first network node comprises a processing circuit configured to:
receive, from a user device, a first query for recommendations on the gift, wherein the first query comprises an identification of the further user;
transform the first query into a second query for recommendations on the gift while taking a user profile for a user of the user device into account, wherein the second query comprises the identification of the further user;
send the second query to the second network node;
receive a second set of recommendations on the gift from a second network node;
determine the first set of recommendations on the gift based on the second set of recommendations and the user profile; and
send the first set of recommendations on the gift to the user device.

35. The first network node according to claim 34, wherein the processing circuit further is configured to customize the second query based on information about purchases by the user.

36. The first network node according to claim 34, wherein the processing circuit further is configured to customize the first set of recommendations on the gift based on information about purchases by the user.

37. The first network node to claim 34, wherein the processing circuit further is configured to receive an indication about a query format from the second network node, and to perform the transforming according to the query format.

38. The first network node according to claim 34, wherein the processing circuit further is configured to filter out private information about the user from the first query and to transfer the identification of the further user and information about the user to the second network node.

39. A second network node configured to provide, to a first network node, a second set of recommendations on a gift to a further user, wherein the second network node comprises a processing circuit configured to:
receive, from the first network node, a second query for recommendations on the gift, wherein the second query comprises an identification of the further user;
generate a third set of recommendations on the gift based on the second query and information about recommendations on gifts; and
send, to a third network node for managing information about the further user, the third set of recommendations and the identification of the further user;
receive the second set of recommendations from the third network node; and
send the second set of recommendations to the first network node.

40. The second network node according to claim 39, wherein the processing circuit further is configured to:
receive information relating to the further user from the third network node; and
customize the third set of recommendations based on the information relating to the further user.

41. The second network node according to claim 39, wherein the processing circuit further is configured to update the information about recommendations on gifts while taking the second set of recommendations on the gift into account.

42. A third network node configured to assist a second network node in providing a second set of recommendations on a gift to a further user, wherein the third network node comprises a processing circuit configured to:
receive a third set of recommendations on the gift from the second network node and an identification of the further user;
generate the second set of recommendations based on a further user profile of the further user and the third set of recommendations on the gift; and
send the second set of recommendations to the second network node.

43. The third network node according to claim 42, wherein the processing circuit further is configured to generate the second set of recommendations based on inventory of the further user.

44. The third network node according to claim 42, wherein the processing circuit further is configured to send information about the further user to the second network node.
